(19) United States
(12) Patent Application Publication
(10) Pub. No.: US 2018/0338427 A1
(43) Pub. Date: Nov. 29, 2018

(54) DEFLECTOR DEVICE, PRESS AND METHOD

(71) Applicant: DEERE & COMPANY, Moline, IL (US)

(72) Inventors: Pascal Gresset, Auxon Dessous (FR); Frederic Perrotin, Le Tremblois (FR); Vincent Duret, Lyon (FR)

(21) Appl. No.: 15/976,068

(22) Filed: May 10, 2018

(30) Foreign Application Priority Data
May 23, 2017 (DE) 102017208761.7

(51) Int. Cl. A01F 15/08; A01F 15/07

(52) U.S. Cl. CPC A01F 15/08; A01F 15/07

(57) ABSTRACT

A press of an agricultural machine for forming bales includes a housing, a pressing means disposed in the housing and a deflector device. The pressing means at least partially forms and surrounds a bale pressing space in which a bale formed by the press is located. The deflector device includes at least one deflector formed in an at least partially movable, flexible manner for reducing material accumulations in a press of a round baler.

### RELATED APPLICATIONS

This application claims priority to German Patent Application Ser. No. 102017208761.7, filed May 23, 2017, the disclosure of which is hereby incorporated by reference in its entirety.

### FIELD OF THE DISCLOSURE

The present disclosure relates to a deflector device for reducing material accumulations in a press, and particularly for a deflector device of an agricultural round baler.

### BACKGROUND

Conventional or known deflector devices are used in presses in order to counteract an accumulation of material inside the press and consequently to prevent a clogging or a blockage of the press or individual or a plurality of operating means of the press. These presses are used both in the agricultural and in the industrial field. Corresponding agricultural presses serve, for example, to form crop bales such as in the case of round bales, and often produce at least substantially round cylindrical bales of harvested crop, for example, such as straw, hay, chopped material, etc. Industrial presses are used in the compression of waste, textiles or other materials or during the pressing thereof into bales.

Some deflector devices direct material away from specific regions or operating means such as, for example, pressing means in the manner of belts, rollers or drums in order to counteract accumulations of material. These deflector devices are generally constructed in the manner of rigid covers, which in particular under difficult harvesting conditions, such as, for example, dry crops, do not operate in an optimum manner.

Thus, there is a need for a deflector device for overcoming the limitations of conventional deflector devices noted above.

### SUMMARY

In a first embodiment of the present disclosure, a deflector device is provided for reducing material accumulations in a press which has at least one deflector constructed in an at least partially movable manner. The deflector may, for example, be moved by means of operation-related vibrations of the press brought about by means of a movement in particular of mechanical operating means or components of the press, such as a receiving device, which introduces material or harvested crops into a bale pressing space, or one or more pressing means which move(s) in order to produce a bale in the bale pressing space, or which occur when the press travels over a particularly uneven surface. The deflector may, for example, be constructed in such a manner that it vibrates, oscillates or also wobbles, whereby an accumulation or depositing or adhesion of material in close proximity of the deflector can be prevented or counteracted. In particular, the deflector may be constructed in a flexible manner, for example, so as to be inherently flexible.

The deflector may be provided so as to be able to be connected at one end by means of one or more retention means advantageously directly or indirectly to a frame of the press. At the other end, the deflector may be provided so as to be at least substantially freely movable or to extend away from the retention means or the frame. The deflector may thus extend, for example, at least in an idle state at least substantially vertically downwards, but it is also possible for it to define an angle with respect to the vertical.

It is particularly simple and cost-effective if the deflector is constructed in one piece. A single-piece construction may further improve the durability of the deflector. The deflector may also be constructed in the form of a lug so that it can protrude or be suspended substantially freely in the region of the press in which an accumulation of material is intended to be counteracted. However, it is also conceivable for the deflector to be constructed in several parts or for the deflector device to have a plurality of deflectors, for example, in order to thereby produce a movement pattern which deviates from a single-piece construction.

In another embodiment, the deflector(s) may be formed by one or more movable plate(s) or to have a plate. The one or more plates may be constructed in a rigid manner or from metal, hard plastics material or another rigid material. It is also possible, however, for the deflector to at least partially comprise a resilient or rubber-like material. The deflector can thus also be retained in a particularly simple manner by the retention means without an articulated connection being required for this purpose. An improved durability can be achieved when the material used has a textile carrier layer.

If the deflector forms at least in the end region thereof a loop, this may counteract fraying, in particular when a textile carrier material is used. As a result of such a loop, an accumulation or aggregation/depositing of material can also be further counteracted, in particular when this region achieves an action which is not only wobbling but also beating. It is also possible to provide at a region facing the retention means a loop which can optionally also be used as a securing possibility or for supporting a securing of the deflector to the frame.

The deflector device may be arranged so as to be adapted to the respective requirements. However, the deflector device may also be orientated at least substantially in a horizontal manner so that a free movement of the deflector(s) is possible to the greatest possible extent.

If a press is provided with one or more of the above-described deflector device(s), this may support the function of the press in that accumulations of material in the press or in one or more regions of the press can be reduced or prevented. In this manner, adhesions or deposits of material or occurrences of clogging of the press and consequently undesirable down-times of the press can be counteracted. Such a press generally has a housing and at least one pressing means which is arranged in the housing. The press may be an agricultural round baler for forming round cylindrical bales. However, the press may also be used in the industrial field, for example, in order to form bales from paper, waste, fabric or other materials.

The deflector device may be arranged in any region of the press in which accumulations of material may occur. However, in one example, it is possible to arrange at least one deflector device between the pressing means and the housing and adjacent or below a wrapping means supply device.

According to another embodiment of this disclosure, a method for operating a round baler is provided. Here, the deflector device during the production of a bale is influenced by vibrations which occur during operation of the press in such a manner that the deflector is caused to move, e.g., oscillate, vibrate or wobble, whereby the deflector can counteract an accumulation of material.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of a press with a deflector device, and

FIG. 2 is an enlarged illustration of the deflector device.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

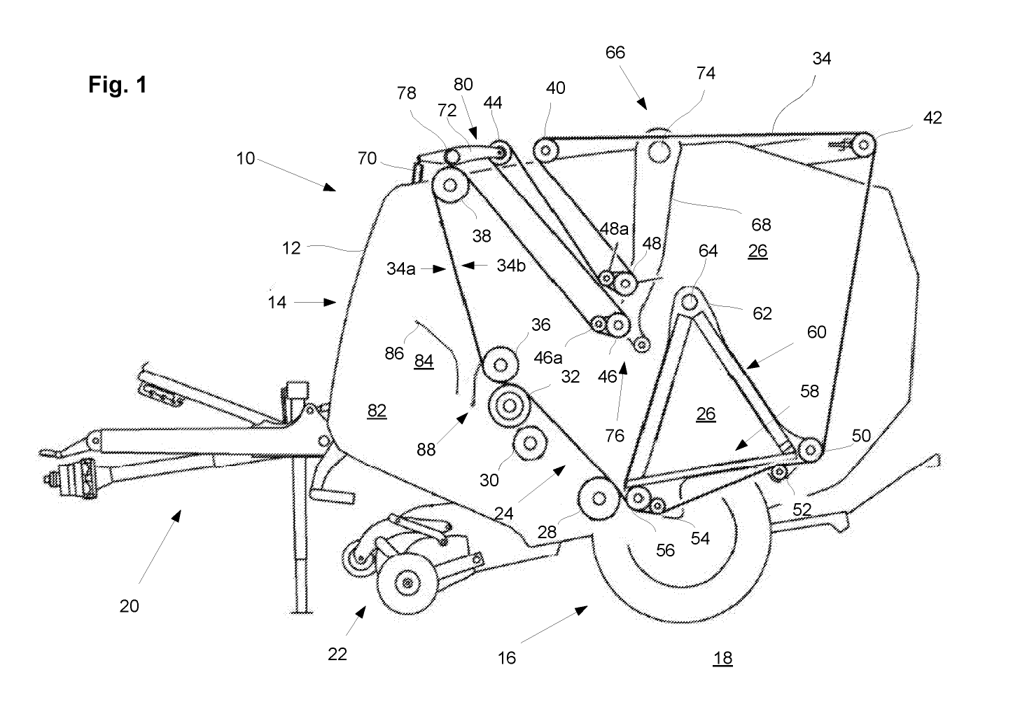

In FIG. 1, an embodiment is shown of a press 10 which has a frame 14 supporting a housing 12 and which is supported via a chassis 16 on a substrate 18. The press 10 may be constructed in the manner of a round baler and can be used both in the agricultural and the industrial fields in order to produce a round, cylindrical bale from harvested crop, but also from waste, paper, fabric or material, cotton, tobacco, etc. The press 10 may be pulled by an operating vehicle which is not shown such as a tractor. Alternatively, the press 10 may be constructed to be self-driving.

According to the present embodiment, a drawbar 20 is provided on the front side of the frame 14 in order to be able to suspend the press 10 on a tractor which is not shown and to pull it across a field. A receiving device 22 in the form of a pick-up serves to receive harvested crop lying on the substrate 18, for example, hay or straw which has been deposited in a swath. The harvested crop received by the receiving device 22 is supplied to an inlet 24 of a bale pressing space 26 and is rolled at that location in a helical manner to form a round cylindrical bale, tied and subsequently placed on the substrate 18.

A lower, fixed roller 28 and two upper rollers 30, 32 are positioned at the inlet 24 of the bale pressing space 26. The bale pressing space 26 is further formed by means of a continuous pressing means 34 which is constructed according to the present embodiment in the form of two pressing belts which abut each other and which is guided around a number of fixed rollers 36, 38, 40, 42 and movable rollers 44, 42, 46, 48, 50, 52, 54, 56. The pressing means 34 has an outer side 34a facing the frame 14 and an inner side 34b.

While the bale pressing space 26 is surrounded at the peripheral side substantially by the pressing means 34 and the rollers 28, 30 and 32, it is laterally delimited by side walls which are not shown.

Four rollers 50, 52, 54, 56 of the movable rollers 44-56 are freely rotatably supported in a lower region 58 of a delta-shaped carrier 60 which is pivotably articulated about the upper tip 62 thereof about an axis 64 which extends horizontally and transversely relative to the forward direction and which can be moved by means of an actuator (not shown) from the bale forming position shown in FIG. 1 into a bale discharge position pivoted upwards to the rear.

A clamping mechanism 66 for tightening the pressing means 34 has a clamping lever 68 which cooperates with a first clamping element (not shown) and a clamping arm 72 which cooperates with a second clamping element 70. Both the clamping element (not shown) and the clamping element 72 can be constructed in conventional manner as a mechanical spring or as a hydraulic motor or may have one.

The clamping lever 68 is supported in the region of the side walls (not shown) about an axis 74 which extends horizontally and transversely relative to the forward direction and carries in an end region 76 facing away from the axis 74 two of the movable rollers 46, 48 and cleaning rollers 46a, 48a which are associated with these rollers 46, 48. The clamping arm 72 is accordingly supported about an axis 78 and carries in an end region 80 one of the movable rollers 44. Furthermore, the clamping arm 68 is operationally connected at one end to the clamping element 70 which is connected at the other end to the press or the frame 14 thereof in a manner not shown.

The pressing means 34 is securely placed against the rotatably driven, fixed roller 38 by means of the clamping arm 70 that it is ensured that it is carried along. The roller 36 is also rotatingly driven. The pressing means 34 assumes a starting state, in which in a state extended in a straight manner it bridges the inlet 24, and an end state, in which it wraps around a bale in the manner of a large loop. The bale pressing space 26 can consequently be changed in terms of its size, that is to say, its diameter increases with the size of the bale 18. The bale is located while it is being formed in the bale pressing space 26 and is surrounded for the most part by the pressing means 34, but falls backwards out of the bale pressing space 26 onto the substrate 18 as soon as the carrier 60 with the movable rollers 50-56 pivots upwards in a counter-clockwise direction when the drawing is viewed. Alternatively, the bale may also be placed on a device which is arranged downstream of the press 10.

One embodiment of the baling press is described in EP 1 308 078 A1. Additional embodiments are described in DE 198 51 470 A1, DE 102 41 215 A1 and EP 1 264 531 A1, the disclosures of which are hereby incorporated by reference. It is also possible, however, for the press 10 to be able to be constructed in the manner of a so-called fixed chamber press whose pressing means are formed by substantially fixed rollers.

In a region 82 of the baling press 10 facing the drawbar 20 there may further be provided a wrapping means supply device 84 which guides a wrapping means (not shown) to a bale formed in the bale pressing space 26. According to the present embodiment, the supply is carried out between the upper rollers 30 and 32. At 86, a housing or frame portion of the wrapping means supply device 84 is illustrated. Adjacent to the housing or frame portion 86, there is a deflector device 88 shown which is provided to counteract an accumulation of material or harvested crop, in particular in a region 90 between the housing or frame portion 86 and the pressing means 34.

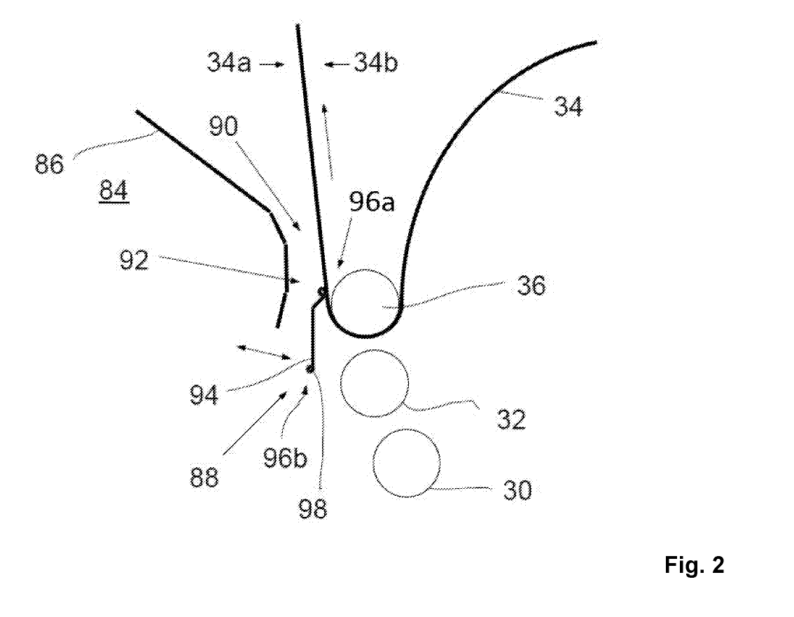

In FIG. 2, the deflector device 88 is shown in an enlarged illustration. The deflector device 88 extends in the region 90 at least substantially over the width of the press 10. Here, the deflector 94 is connected to the frame 14 of the press 10 via retention means 92 which are illustrated only by way of indication and extends away from it. The deflector device 88 is arranged between the pressing means 34 and a housing or frame portion 86 of a wrapping means supply device 84. The deflector device is arranged in such a manner that non-pressed material being discharged from the bale pressing space 26 is at least partially caught by the deflector device 88. Consequently, the material discharged from the bale pressing space is prevented from reaching a front region of the baling press, in particular a region of the wrapping means supply device 84 in order to settle at that location. Instead, there is provision for the material caught by the deflector device 88 to bounce off without material accumulations and to fall down in the direction of the receiving device 22.

The deflector 94 is at least partially constructed in the manner of a movable or flexible lug. According to the illustrated embodiment, the deflector 94 is provided in one piece and is substantially formed by means of a rubber-like material which is applied to a textile carrier material, wherein the term “rubber” is not limited to natural rubber, but instead is intended to include any other suitable material including a plastic material. Both in the end region 96a, b thereof facing and facing away from the retention means 92, the deflector 94 forms a loop 98 which reinforces the respective end region 96a, b and can counteract fraying.

During operation, the press 10 is moved by means of the operating vehicle (not shown) over a generally uneven substrate. Furthermore, various components or operating means of the press 10 are moving. Thus, for example, the receiving device 22 supplies harvested crop to the bale pressing space 26 to form a bale. Furthermore, the pressing means 34 is moved as shown in FIGS. 1 and 2 (see arrow A). The vibrations induced by the press 10 by means of which the flexible deflector 94 is moved and, for example, depending on the strength and type of the vibrations which occur and the precise construction of the deflector 94, vibrates, wobbles or oscillates. As a result of the movement of the deflector 94, a deposit of material which, for example, under difficult, in particular dry, harvesting conditions may be introduced from the actual bale pressing space 26 in the region of the rollers 28-32 or rollers 36-56 into the surrounding housing 12 is counteracted. In this manner, a deposit or adhesion of material, in particular in regions around the housing or frame portion 86 of the wrapping means supply device 84, can be counteracted.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A deflector device for reducing material accumulations in a press of a round baler, comprising at least one deflector formed in an at least partially movable, flexible manner.

2. The deflector device of claim 1, wherein the deflector comprises a first end and a second end, the first end configured to be coupled by at least one retention means to a frame portion of the press, and which extends at the second end so as to be substantially freely movable.

3. The deflector device of claim 1, wherein the at least one deflector is substantially constructed as one piece.

4. The deflector device of claim 1, wherein the deflector comprises a partially resilient material.

5. The deflector device of claim 1, wherein the deflector comprises a rubber-like material having a textile carrier layer.

6. The deflector device of claim 4, wherein the deflector forms a loop at least in one of the end regions thereof.

7. The deflector device of claim 1, wherein the at least one deflector is configured to extend at least substantially horizontally with respect to a frame portion of the press.

8. A press of an agricultural machine for forming bales, comprising:
a housing;
at least one pressing means disposed in the housing, the pressing means at least partially forming and surrounding a bale pressing space in which a bale formed by the press is located; and
a deflector device comprising a movably flexible deflector.

9. The press of claim 8, further comprising a wrapping means supply device including a frame portion, wherein the deflector device is disposed between the pressing means and the frame portion of the wrapping means supply device.

10. The press of claim 8, wherein the deflector device is arranged such that non-pressed material discharged from the bale pressing space is at least partially caught by the deflector device.

11. The deflector device of claim 1, wherein the deflector comprises a first end and a second end, the first end being coupled by at least one retention means to a frame of the press, and which extends at the second end so as to be substantially freely movable.

12. The press of claim 8, wherein the deflector is substantially constructed as one piece.

13. The press of claim 8, wherein the deflector comprises a partially resilient material.

14. The press of claim 8, wherein the deflector comprises a rubber-like material having a textile carrier layer.

15. The deflector device of claim 14, wherein the deflector forms a loop at least in one of the end regions thereof.

16. The deflector device of claim 1, wherein the at least one deflector is configured to extend at least substantially horizontally with respect to a frame portion of the press.

17. A method for operating a press of an agricultural machine, comprising:
providing the press having a housing, a pressing means disposed in the housing, a bale pressing space formed by the pressing means, and a deflector device comprising a movably flexible deflector;
operating the press during a baling process;
forming a bale of material by the press during the baling process;
inducing a vibration during the forming step; and
moving the deflector to redirect non-pressed material discharged from the bale pressing space from accumulating in a front region of the press.

18. The method of claim 17, wherein the moving step comprises vibrating, oscillating or wobbling the deflector to counteract an accumulation of material.

19. The method of claim 17, wherein the forming step comprises disposing the bale formed by the press in the bale pressing space.

20. The method of claim 17, wherein:
the providing step comprises providing a wrapping means supply device and a receiving device; and
the moving step comprises directing the non-pressed material to collect in the receiving device and not accumulating at the wrapping means supply device.
